(19) United States
(12) Patent Application Publication
(10) Pub. No.: US 2005/0241166 A1
(43) Pub. Date: Nov. 3, 2005

(54) Thread setting plug gage

(76) Inventor: Robert D. Porter, Ellisville, MO (US)

Correspondence Address: Henry W. Cummings, 3313 W. Adams St., St. Charles, MO, 63301, US

(21) Appl. No.: 10/759,822

(22) Filed: Jan. 20, 2004

(51) Int. Cl. G01B 5/20

(52) U.S. Cl. 33/501.19

(57) ABSTRACT

A thread ring gage testing and setting device including one end for testing “GO” ring gages, a second end for testing “NO GO” ring gages. Structure to test for a thread ring gage undersize effective minor diameter includes a non-threaded cylindrical portion on each end. Structure for testing thread ring gage oversize minor diameter includes a non-threaded cylindrical portion located at the innermost position of each end, and is of greater diameter than said means for testing thread ring undersize effective minor diameter.

### BACKGROUND OF THE INVENTION

A. Field of the Invention

The present invention generally relates to hand-held measuring devices and, more particularly, to a new and improved master thread setting plug gage adaptable for setting a thread ring gage to size; detecting wear in the thread flanks; and, easily determining the effective minor diameter condition of the thread ring gage being tested. Three embodiments are illustrated and described.

B. Description of the prior art

The Thread Ring Gage

Thread ring gages are used to check the functional size of product thread such as a bolt. The “Go” thread ring gage represents the largest size of the product thread and should assemble with the bolt. The “No Go” thread ring gage represents the smallest size of the product thread and should not assemble with the bolt. This simple checking procedure assures that the bolt has been manufactured within its design limits.

Thread Ring Gage Terminology

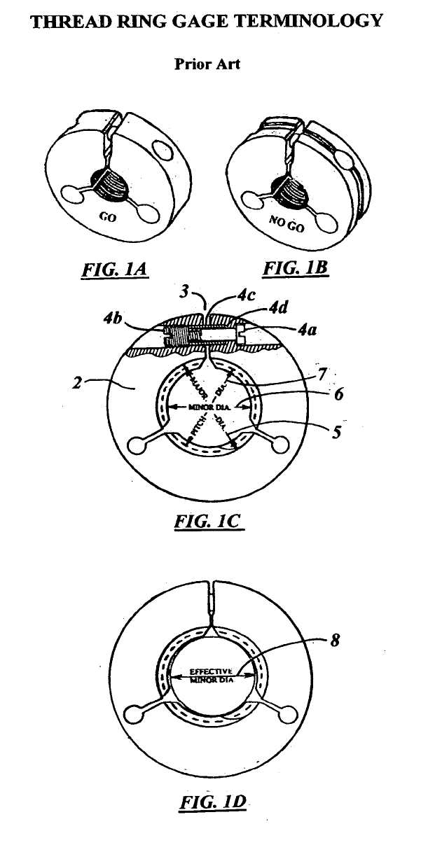

The thread ring gage (FIGS. 1A-1D) includes a body portion 2 with a slot 3 with an adjusting assembly 4a-4d.

The Major Diameter 5 on a straight thread, is a diameter of the coaxial cylinder that would bound the crest of an external thread or the root of an internal thread.

The Minor Diameter 6 on a straight thread, is the diameter of the coaxial cylinder that would bound the root of an external thread, or the crest of an internal thread.

The Pitch Diameter 7 on a straight thread, is the diameter of the coaxial cylinder, the surface of which would pass through the thread profiles at such points as to make the width of the groove equal to one-half of the basic pitch. On a perfect thread this occurs at the points where the widths of the thread and groove are equal.

The Effective Minor Diameter 8 is effected when thread ring gages wear and are readjusted, which causes an eccentric condition between the thread pitch and minor cylinders which often results in an undersize effective minor diameter (see FIG. 1D) which can encroach on the maximum permissible limit for the root profile of the product external thread. This encroachment can result in a loss of manufacturing tolerance for the product; and/or, can result in the rejection of an acceptable product when the ring gages are used to inspect a vendor product, for example.

Inspection facilities ordinarily available in the field are often inadequate for determining the important pitch and effective minor diameter elements of the thread ring gage.

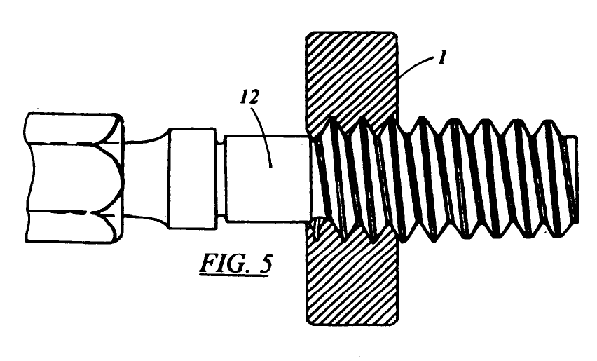

Thread setting plug gages are used primarily as master gages to set adjustable “Go” and “No Go’ thread ring gages to size, but are also used to set other gages such as indicating gages and snap thread gages, for example. FIG. 6, of I. T. Wedin U.S. Pat. No. 2,793,443 (1957) discloses a setting gage 36 for testing a thread ring gage 11.

Each of the three embodiments of the Improved Thread Setting Plug Gage of the present invention not only function as a normal thread setting gage, but also easily control the interrelated and difficult to measure pitch and minor diameter elements of the thread ring gage.

Proper use of truncated thread setting plug gages includes when using the truncated plug, the thread ring gage should be adjusted to fit the full thread portion, after which the fit of the ring on the truncated portion should be determined. If there is any appreciable shake or play, on either side of the ring, the ring gage should be re-lapped or discarded.

Hilo Setting Plug Gages

These plug gages such as in J. E. Finley U.S. Pat. No. 2,789,360 (1957), the “GO” thread ring gage, as an example, is set to the front and or “Lo” portion of the HILO plug gage (which represents the lower limit of the “GO” ring gage pitch diameter tolerance). When the back or “Hi” portion (which represents the upper limit of the “GO” ring gage pitch diameter tolerance) enters the ring gage, the ring is out of tolerance and should be reset, re-lapped or discarded.

As shown in FIG. 1C, to utilize the adjusting assembly (4a-4d), to adjust the ring, first loosen the locking screw 4a. This permits the split adjusting screw 4b to be screwed back or forth on its external thread. To spread the ring—adjusting screw 4b is turned clockwise exerting a pressure on the sleeve 4c and against the shoulder 4d in the right hand side of the gage. To reduce the size of the ring, turn the adjusting screw 4b counter clockwise, reducing pressure of sleeve 4c against shoulder 4d. Locking the adjustment is accomplished by turning the locking screw 4a clockwise, exerting a pull between the shoulder immediately under the head of the locking screw 4a and internal threads of the adjusting screw 4b confining sleeve 4c securely between the body shoulder 4d and the adjusting screw 4b. Sleeve 4c must be securely locked if ring is to retain its setting. Make adjustment while the ring is on the setting plug. Tighten the locking screw securely before removing ring gage from setting plug.

Worn adjustable thread ring gages may frequently be salvaged by re-lapping the Threads, to restore thread form and roundness, and refinishing the minor diameter. Gages thus salvaged are reworked to tolerances used in the manufacture of new gages.

### SUMMARY OF THE INVENTION

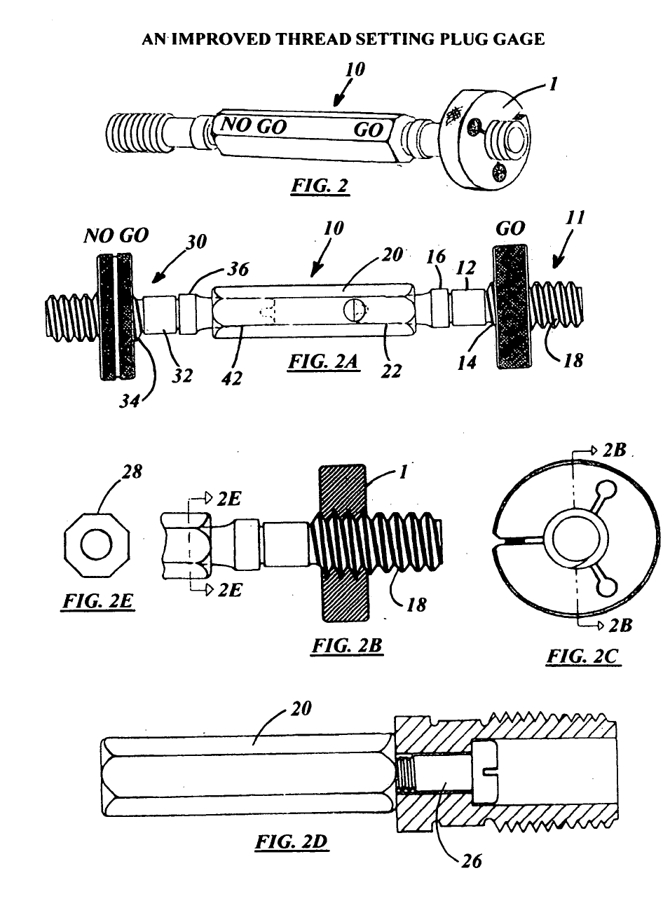

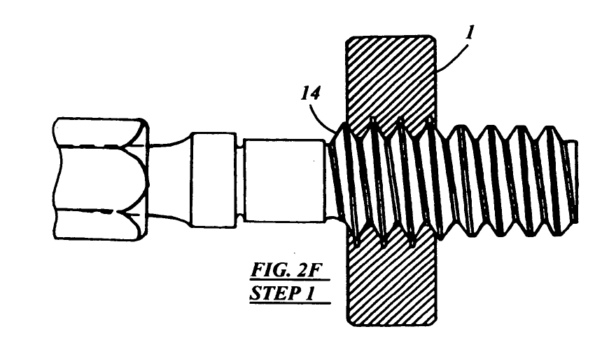

FIGS. 2-2D illustrate an improved thread setting plug gage 10 including an upper limit “GO” thread gage end 11 and lower limit “NO GO” end 30 which are mirror images of each other except the size of the “NO GO” end 30 is of smaller dimensions because it is used to test lower limit gages. For convenience these respective portions will be discussed together. In one embodiment the plain cylindrical portions 12, 32 of the gage 10 immediately behind the threaded section 14, 34 of the gage are used to check the minimum effective minor diameter 8 (FIG. 1D) of the ring gage. The minor diameter of the thread ring gage should clear the section 12, 32 of the gage. The larger plain cylindrical part 16, 36 of the gage immediately behind the minimum effective minor diameter checks the maximum size of the minor diameter of the ring gage, which should not enter this section of the setting gage. The thread setting gage is attached to a handle 20 of an octagon cross section 28 FIG. 2E, either by a taper fit 22, 42 or with a bolt 26 for a larger gage, as illustrated in FIG. 2D.

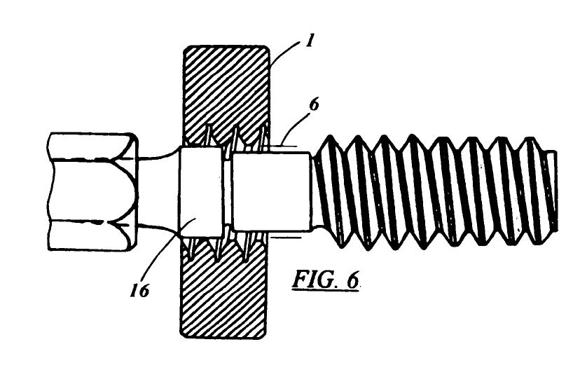

In the second embodiment shown in FIG. 7 the improved thread setting plug gage 60 has “GO” and “NO GO” ends 61 and 62, with the plain cylindrical effective minor diameter checking sections 62a and 67 located in the approximate center of the ends 61 and 62, between the full form threaded entry section 64 and the truncated thread section 66 at the “GO” end 61, and at the “NO GO” end 62 between threaded section 65 and truncated section 63.

This setting gage is made and used differently than the gage in FIGS. 2-6, which has a constant pitch diameter for the length of the thread. The pitch diameter of the threaded section 64, 65 is manufactured to the lower limit of the respective thread ring pitch diameter tolerance. The back truncated thread sections 63, 66 are manufactured to the upper limit of the thread ring pitch diameter.

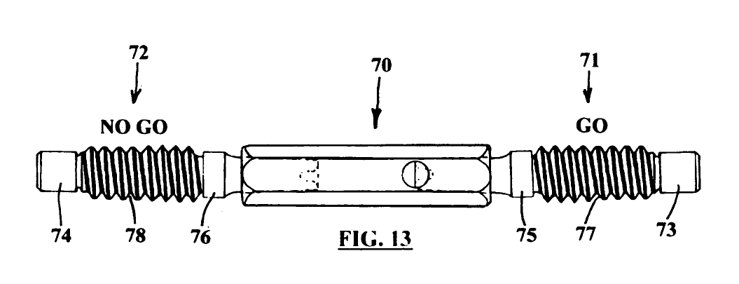

In the third embodiment shown in FIG. 13, the improved thread setting plug gage 70 has “GO” and “NO GO” ends 71, 72, with the plain cylindrical effective minor diameter checking sections 73, 74 located outwardly from threaded sections 77, 78. The larger plain cylindrical maximum minor diameter checking sections 75, 76 are located inwardly from threaded sections 77, 78.

The Improved Thread Setting Plug Gage of the present invention not only functions as a normal thread setting gage, but also easily controls the important and difficult to measure pitch and minor diameter elements of the thread ring gage.

### DESCRIPTION OF PREFERRED EMBODIMENTS

Step 1. In use, using the “GO” end as an example, the thread ring gage 1 is adjusted with assembly 4a-4d to fit the full thread form section 14 of the improved thread setting plug gage as shown in FIG. 2F.

Step 2. The ring gage 1 is then advanced toward the plain cylindrical effective minor diameter testing section 12 of the setting gage as shown in FIG. 2G. If the ring clears this section of the setting gage, it proves that the minor diameter of the ring gage is above minimum size and should not encroach upon the product thread. This effective minor diameter checking feature is a very important element of the present invention.

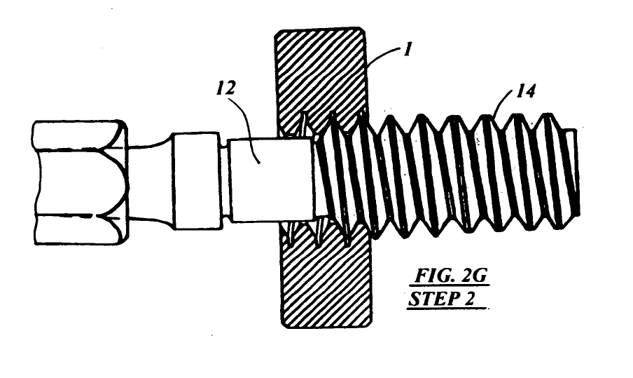

Step 3. The thread ring gage 1 is then further advanced toward the larger plain cylindrical section 16 of the setting gage, as shown in FIG. 3. The minor diameter of the ring gage is within tolerance if it stops at this section 16 of the setting gage, which represents the upper size limit for the minor diameter.

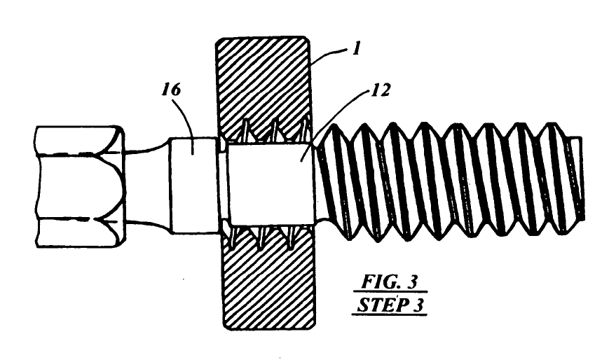

Step 4. The fit of the ring gage 1 is then checked on the truncated thread section 18 at the front of the setting gage as shown in FIG. 4. If there is no change in the fit of the ring gage, the gage is acceptable. If there is any change (looseness) in the fit of the ring gage on the truncated section 18, it is an indication that the thread flanks 9 of the ring gage are worn excessively and should be reworked or discarded.

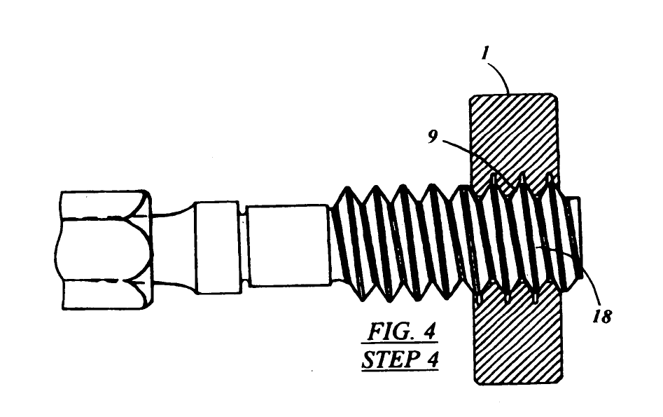

In FIG. 5, in this example, after adjustment to fit the setting gage, the thread ring gage 1 is worn to the extent that the minor diameter of the ring gage will not clear the minimum effective minor diameter testing section 12 of the improved thread setting plug gage 10. An undersize effective minor diameter is the most common (and costly) defect to be found in adjustable thread ring gages, and often goes undetected. If a thread ring gage is used in this condition it will result in a loss of manufacturing tolerance for the product. If this undersize gage is used to inspect a vendor product, it could cause reject on an in-tolerance part. Ordinary thread setting plug gages such as J. E. Finley U.S. Pat. No. 2,789,360 (1957), or the setting gage 36 depicted in I. T. Wedin U.S. Pat. No. 2,793,443 (1957), will not detect an out of tolerance minor diameter condition. This improved thread setting gage of the present invention will quickly detect thread ring gages having an out of tolerance minor diameter, and may help to resolve disputes between manufacturer and customer.

In FIG. 6, the minor diameter 6 of the thread ring gage 1 clears the maximum minor diameter section 16 of the thread ring gage, showing that the thread ring gage is oversize and out of tolerance. The improved thread setting plug gage will quickly and easily detect such an out of tolerance minor diameter. Ordinary thread setting gages such as in U.S. Pat. No. 2,789,360 (1957), or the setting gage 36 depicted in U.S. Pat. No. 2,793,443 (1957) will not detect this oversize minor diameter condition. This same procedure is repeated at the opposite end 30 to test the “NO GO” ring gage.

FIG. 7 illustrates an alternate improved thread setting plug gage 60 with the effective minor diameter checking sections 62a, 67 located respectively in the approximate center of the gage. This setting gage is made and used differently than the gage in FIGS. 2-6, which has a constant pitch diameter for the length of the thread. In this embodiment, the pitch diameter of the threaded front sections 64, 65 is manufactured to the lower limit 69a, 69 of the respective thread ring gage pitch diameter tolerance. The back truncated thread sections 63, 66 are manufactured to the upper limit 68a, 68 of the respective thread ring gage pitch diameter tolerance.

In use, the “GO” or “NO GO” thread ring gage being checked is set to fit the respective thread front sections 64, 65 of the improved thread setting plug gage. It is then advanced toward, and should clear, the plain cylindrical effective minor diameter sections 62a, 67 of the setting gage. The thread ring gage should not assemble with the truncated thread sections 63, 66 at the back of the setting gage. The pitch diameter and effective minor diameter elements of the thread ring gage are considered to be within tolerance if it passes this test.

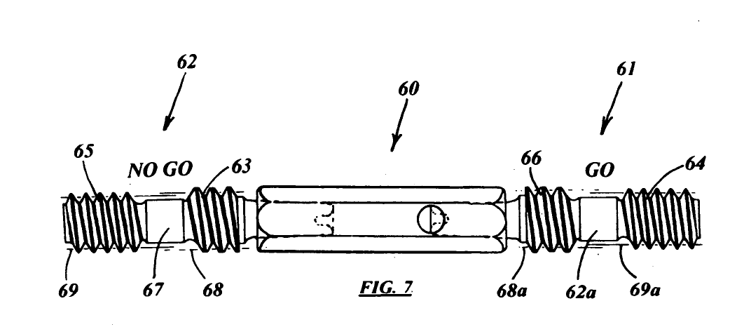

In FIG. 8, Step 1, again using the “GO” end as an example, the GO” thread ring gage 1 being tested is set to the front threaded section 64 of the improved thread setting gage, which represents the lower tolerance limit of the thread ring gage pitch diameter.

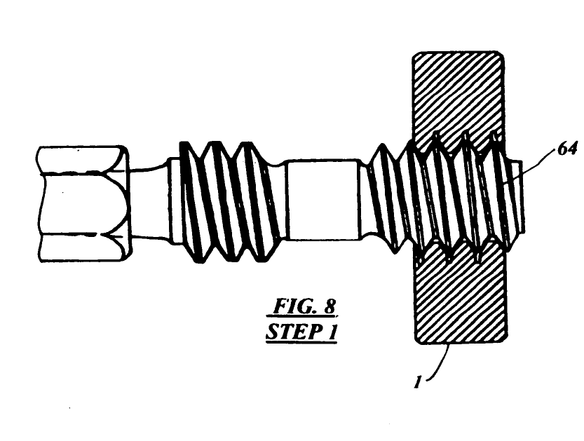

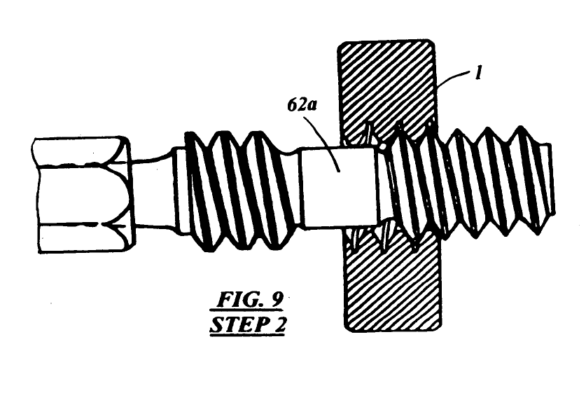

In FIG. 9, Step 2, the thread ring gage 1 is advanced toward, and should clear, the plain cylindrical effective minor diameter checking section 62a of the setting gage.

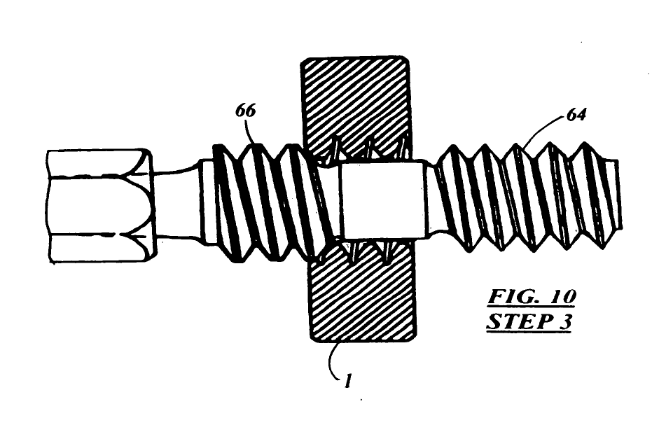

In FIG. 10, Step 3, the thread ring gage 1 is then advanced toward the truncated thread 66 of the setting gage, which represents the upper tolerance limit of the thread ring gage pitch diameter. The thread ring gage being tested should not assemble with the truncated section 66 of the setting gage. If this is the case, the thread ring gage is then considered to be within tolerance and is ready for use.

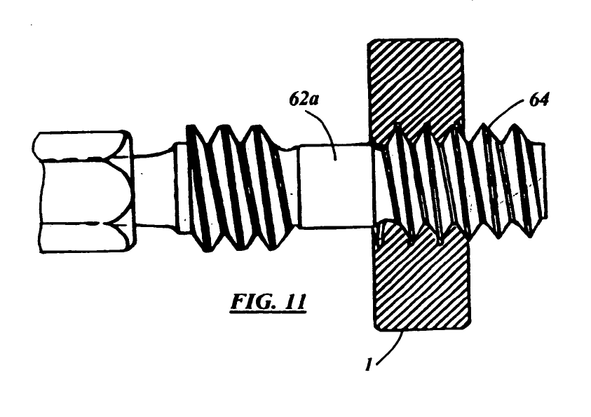

In FIG. 11, the thread ring gage 1 has been adjusted to fit the front section 64 of the improved thread setting plug gage, and then advanced toward the plain cylindrical effective minor diameter section 62a. The minor diameter of the worn thread ring gage has been closed down to the extent that it will not clear the plain cylindrical section 62a of the setting gage. The thread ring gage 1 is not acceptable for use and should be reworked or discarded.

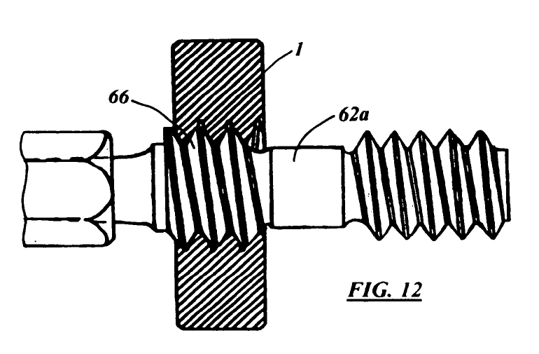

In FIG. 12, the thread ring gage has been adjusted to fit the front section 64 of the improved thread setting plug gage 60. The ring gage minor diameter has cleared the plain cylindrical effective minor diameter section 62a of the setting gage, and has also assembled with the truncated thread section 66 at the back of the setting gage, which represents the upper size limit of the thread ring gage. When this occurs, it means that the ring gage is worn excessively and is not acceptable for use and should be reworked or discarded.

This same procedure is repeated at the opposite end 62 to test the “NO GO” thread ring gage.

Inspection facilities ordinarily available in the field are often inadequate for determining the important pitch and effective minor diameter elements of the thread ring gage.

The Improved thread setting plug gage of the present invention not only functions as a normal thread setting gage, but also easily controls the important and difficult to measure pitch and effective minor diameter elements of the thread ring gage. FIG. 13 illustrates another alternate improved thread setting plug gage 70 including an upper limit “GO” thread gage end 71 and lower limit “NO GO” end 72 which are mirror images of each other except the size of the “NO GO” end 72 is of smaller dimensions because it is used to test lower limit gages. For convenience these respective portions will be discussed together. In this embodiment the plain cylindrical portions 73, 74 located immediately in front of the threaded sections 77, 78 are used to check the minimum effective minor diameter 8 (FIG. 1D) of the ring gage. The minor diameter of the thread ring gage should clear the section 73, 74 of the gage. The larger plain cylindrical part 75, 76 of the gage immediately behind the threaded section 77, 78 checks the maximum size of the minor diameter of the ring gage, which should not enter this section of the setting gage.

In use, the “GO” or “NO GO” thread ring gage being checked should clear the plain cylindrical effective minor diameter checking sections 73, 74 of the improved thread setting plug gage. The thread ring is then advanced onto the threaded section 77, 78 of the gage and checked for fit on the full form section of the setting gage. If the fit of the ring gage is acceptable, it is then advanced toward, and should not assemble with, the larger plain cylindrical part 75, 76 of the gage which checks the maximum size of the minor diameter of the ring gage. The fit of the ring gage is then checked on the truncated section of the setting gage thread. If there is no change (looseness) in the fit of the ring gage, the pitch diameter and minor diameter elements of the thread ring gage are considered to be within tolerance if it passes this test.

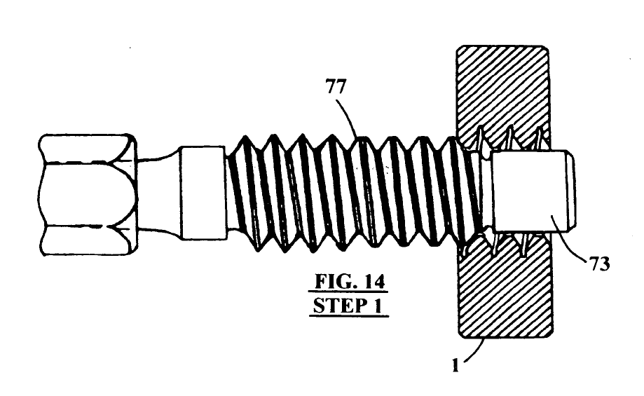

In FIG. 14, Step 1, again using the “GO” end as an example, the “GO” thread ring gage 1 has cleared the plain cylindrical testing section 73 of the improved thread setting gage which checks the minimum acceptable effective minor diameter condition of the ring gage. The ring gage has also started to assemble with the threaded section 77 of the setting gage.

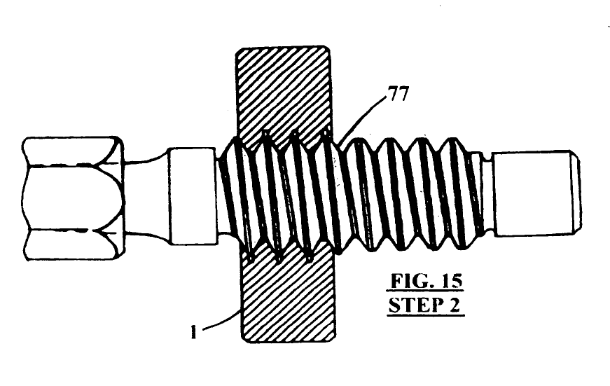

FIG. 15, Step 2, the thread ring gage 1 has been advanced to, and has assembled with, the full form section of thread 77. The fit of the ring gage is checked, and adjusted to fit if any looseness is detected.

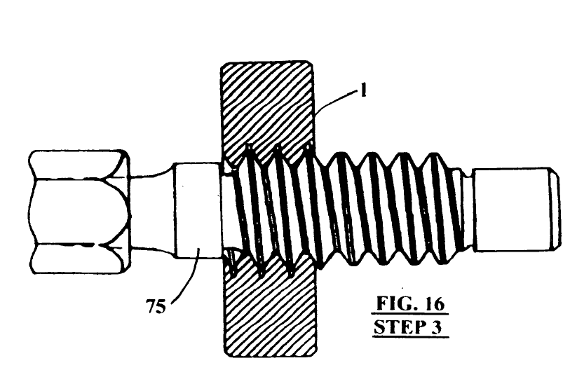

FIG. 16, Step 3, the thread ring gage 1 is then advanced toward the larger plain cylindrical section 75 located at the back of the gage. The thread ring gage should not assemble with this section of the setting gage which represents the upper size limit of the thread ring gage minor diameter. If the ring gage had assembled with the plain cylindrical section 75 of the setting gage, the minor diameter of the ring gage would be worn to the extent that it should be rejected and removed from service.

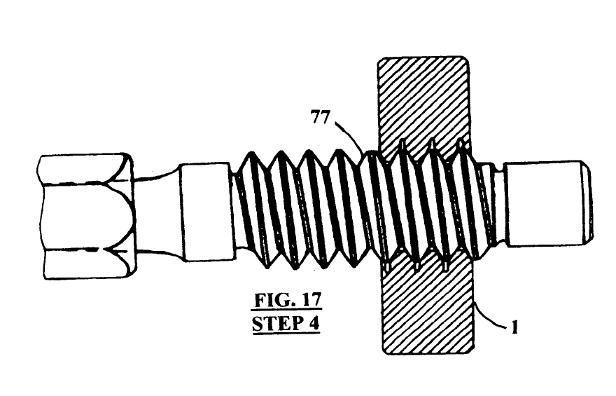

FIG. 17, Step 4. The thread ring gage 1 is then tested for fit on the truncated part of the threaded section 77 of the improved thread setting gage. If there is no change in the fit of the ring gage, the gage is now considered acceptable to use. If there had been a change in the fit (looseness), it is an indication of wear in the thread flanks of the ring gage. If that is the case, the ring gage should be rejected and reworked to new gage tolerances, or discarded.

This same procedure is repeated at the opposite end 72 to test the “NO GO” thread ring gage. Inspection facilities ordinarily available in the field are often inadequate for determining the important pitch and effective minor diameter elements of the thread ring gage.

The Improved Thread Setting Plug Gage of the present invention not only functions as a normal thread setting gage, but also easily controls the important and difficult to measure pitch and effective minor diameter elements of the thread ring gage.

1. A thread ring gage testing and setting device comprising:
A threaded outer portion for testing a thread ring gage;
A first non-threaded cylindrical portion of smaller diameter than said outer portion located inwardly from said threaded outer portion to test for a thread ring gage undersize effective minor diameter; and
a second non-threaded cylindrical portion of larger diameter than said first non-threaded cylindrical portion located inwardly from said first non-threaded cylindrical portion to test for a thread ring gage over size minor diameter.

2. A thread ring gage testing device according to claim 1 wherein a groove is provided between first non-threaded cylindrical portion and said second non-threaded cylindrical portion.

3. A thread ring gage testing device according to claim 1 wherein the outside diameter of said threaded portion varies.

4. A thread ring gage testing device comprising: A threaded outer portion at one end for testing a “GO” thread ring gage;
a first non threaded cylindrical portion of smaller diameter than said outer portion located inwardly from said threaded outer portion to test for a thread ring gage undersize effective minor diameter; and
a second non-threaded cylindrical portion of larger diameter than said first non-threaded cylindrical portion located inwardly from said first non-threaded cylindrical portion to test for a thread ring gage over size minor diameter;
a second threaded outer portion located at a second end for testing a “NO GO” thread ring gage;
a third non-threaded cylindrical portion of smaller diameter than said second threaded outer portion to test for a thread ring gage undersize minor diameter; and
a fourth non-threaded cylindrical portion of larger diameter than said third non-threaded cylindrical portion located inwardly from said third non-threaded cylindrical portion to test for a thread ring gage oversize minor diameter.

5. A thread ring gage testing device according to claim 4 wherein a groove is provided between said first non-threaded cylindrical portion and said second non-threaded cylindrical portion, and between said third non-threaded cylindrical portion and said fourth non-threaded cylindrical portion.

6. A thread ring gage testing device according to claim 5 wherein the outside diameter of each of said threaded portion varies.

7. An improved thread ring gage testing device for testing “GO” and “NO GO” thread ring gages comprising:
Longitudinally spaced effective minor diameter cylindrical checking sections located respectively in the approximate center of the respective “GO” and “NO GO” gage portions; longitudinally spaced front threaded sections having pitch diameters formed to the lower limit of the thread ring gage pitch diameter tolerance; and longitudinally spaced back truncated thread sections formed to the upper limit of the thread ring gage pitch diameter tolerance of said gage.

8. A method of testing a thread ring gage comprising:
Providing a thread ring gage to be tested for tolerance compliance;
Providing a thread setting plug gage;
Adjusting said thread ring gage to fit on a first full threaded section of said plug gage;
Advancing said thread ring gage toward a first cylindrical section of said setting gage;
Determining whether said thread ring gage clears said first cylindrical section of said setting gage, which represents the minimum acceptable effective minor diameter.
Advancing said thread ring gage further toward a second, larger diameter plain cylindrical section;
Determining if said ring gage stops at said second, larger diameter plain cylindrical section; which represents the upper size limit for the minor diameter of said ring gage.
Advancing said thread ring gage in the opposite direction toward a truncated section located at a front portion of said setting gage; and
determining whether or not there is a change in the fit of said ring gage on said truncated section.

9. A method according to claim 8 including reworking the thread flanks of said ring gage to place said thread flanks within tolerance and rechecking said thread flanks.

10. A method according to claim 8 including discarding said ring gages which will not clear said first cylindrical effective minor diameter testing section of said thread setting plug gage.

11. A method according to claim 8 including discarding said ring gages in which said thread ring gage clears said maximum minor diameter testing section of said thread plug gage.

12. An improved thread ring gage testing device for testing, “GO” and “NO GO” thread ring gages comprising:
A threaded portion for testing a thread ring gage;
A first non-threaded cylindrical portion of smaller diameter located outwardly from said threaded portion to test for a thread ring gage undersize effective minor diameter; and;
A second non-threaded cylindrical portion of larger diameter than said first non-threaded cylindrical portion located inwardly from said threaded portion to test for a thread ring gage oversize minor diameter.

13. A thread ring gage testing device according to claim 12 wherein a starting chamfer is provided on the outward end of first non-threaded cylindrical portion to facilitate assembly with the thread ring gage.

14. A thread ring gage testing device according to claim 12 wherein a groove is provided between first non-threaded cylindrical portion and said threaded portion.

15. A thread ring gage testing device according to claim 12 wherein the outside diameter of said threaded portion varies.

16. A thread ring gage testing device comprising:
A threaded outer portion at one end for testing a “GO” thread ring gage;
a first non-threaded cylindrical portion of smaller diameter than said outer portion located outwardly from said threaded outer portion to test for a thread ring gage undersize effective minor diameter; and
a second non-threaded cylindrical portion of larger diameter than said first non-threaded cylindrical portion located inwardly from said threaded outer portion to test for a thread ring gage over size minor diameter.
A second threaded outer portion located at a second end for testing a “NO GO” thread ring gage;
A third non-threaded cylindrical portion of smaller diameter than said second threaded outer portion to test for a thread ring gage undersize minor diameter; and
a fourth non-threaded cylindrical portion of larger diameter than said third non-threaded cylindrical portion located inwardly from said threaded outer portion to test for an oversize minor diameter.

17. A thread ring testing device according to claim 16 wherein a starting chamfer is provided on the outward end of said third non-threaded cylindrical portion to facilitate assembly with the thread ring gage.

18. A thread ring testing device according to claim 16 wherein a groove is provided between said third non-threaded cylindrical portion and said second threaded portion.

19. A thread ring gage testing device according to claim 16 wherein the outside diameter of each of said threaded portion varies.

20. A thread ring gage testing and setting device comprising:
one end for testing “GO” ring gages,
a second end for testing “NO GO” ring gages,
means to test for a thread ring gage undersize effective minor diameter,
means for testing the pitch diameter of a thread ring gage, and
means to test for a thread ring gage oversize minor diameter.

21. A thread ring gage testing and setting device according to claim 20
wherein said end for testing “GO” ring gages is substantially identically configured to said end for testing “NO GO” ring gages.

22. A thread ring gage testing and setting device according to claim 20
wherein said means for testing a thread ring gage undersize effective minor diameter comprises a non-threaded cylindrical portion on each end.

23. A thread ring gage testing and setting device according to claim 20
wherein said means for testing the pitch diameter of a thread ring gage comprises a threaded portion on each end.

24. A thread ring gage testing and setting device according to claim 20
wherein said means for testing thread ring gage oversize minor diameter comprises a non-threaded cylindrical portion located at the innermost position of each end, and is of greater diameter than said means for testing thread ring undersize effective minor diameter.
